(19) United States
(12) Patent Application Publication
(10) Pub. No.: US 2013/0302027 A1
(43) Pub. Date: Nov. 14, 2013

(54) OPTICAL MEASUREMENT METHOD AND SYSTEM

(71) Applicants: Stuart Murdoch, Auckland (NZ); Douglas Reid, Dublin (IE); Liam Barry, Dublin (IE); Regan Watts, Dublin (IE)

(72) Inventors: Stuart Murdoch, Auckland (NZ); Douglas Reid, Dublin (IE); Liam Barry, Dublin (IE); Regan Watts, Dublin (IE)

(73) Assignee: DUBLIN CITY UNIVERSITY, Dublin (IE)

(21) Appl. No.: 13/821,210

(22) PCT Filed: Feb. 28, 2011
(86) PCT No.: PCT/EP2011/052946

§ 371 Date: Apr. 25, 2013

(30) Foreign Application Priority Data
Sep. 9, 2010 (EP) 1014994.6

(51) Int. Cl. H04B 10/07

(52) U.S. Cl. CPC H04B 10/07
USPC 398/16

(57) ABSTRACT

The present application is directed to the measurement of the intensity and phase of high speed optical signals. The present application uses a tunable optical local oscillator, an optical coupler, a photodiode and RF electronics. The tunable laser enables successive measurements to be taken across the optical spectrum allowing the system to measure extremely high bandwidth signals. The signal generated by the local oscillator comprises a component at a frequency between two adjacent modes of the periodic optical signal to be measured. The local oscillator and said periodic signal are optically mixed and sent to a photodiode, the measurement of the phase being based on isolating the resulting beat frequencies. This approach offers a significant improvement over existing time resolved approaches which are limited to the bandwidth of the photodiode (˜50 GHz).

### RELATED APPLICATIONS

The present application claims the priority of GB1014994.6 filed on 9 Sep. 2010, the entire contents of which are hereby incorporated by reference.

### FIELD

The present application relates to the measurement of the intensity and phase of high speed optical signals.

### BACKGROUND OF THE INVENTION

As optical communications systems develop, there is an associated development of a need for measurement systems to measure the performance and operation of optical communication systems which use advanced modulation formats and the measurement of ultra-short optical pulses sources. In particular, it is desirable to be able to measure the intensity and phase of such optical signals. The measurement of the intensity and phase of optical waveforms has been a focus of extensive research, initially for the investigation of ultra-short laser pulses and more recently for optical arbitrary waveform generation and optical communication systems. Advanced modulation formats, which were first developed in wireless communication systems, are now widely used in optical communications. These formats such as for example DPSK, DQPSK and QAM incorporate data on both the intensity and phase of the optical carrier. The development and optimization of these complex systems require improved phase sensitive measurement techniques.

One common method of measuring high bandwidth optical signals is the use of a photodiode and a high speed oscilloscope. Unfortunately the photodiode is only sensitive to the optical intensity and therefore gives no optical phase information. Secondly, the measurement is limited to the bandwidth of the photodiode and the oscilloscope (˜50 GHz).

To measure both the intensity and the phase coherent optical receivers (U.S. Pat. No. 4,596,052) are commonly used. Unfortunately coherent receivers are still bandwidth limited by the photodiode and oscilloscope. In addition, because they use the optical local oscillator as the phase reference, a low linewidth local oscillator is required.

One technique which has been discussed to extend the bandwidth of the measurements of complex optical spectra is the use of a tunable laser-Szafraniec, B.; Lee, A.; Law, J. Y.; McAlexander, W. I.; Pering, R. D.; Tan, T. S.; Baney, D. M.;, “Swept coherent optical spectrum analysis,” Instrumentation and Measurement, IEEE Transactions on, vol. 53, no. 1, pp. 203-215, February 2004.

The discussed method uses a high speed optical modulator to mix the spectral modes of the signal and measure the spectral phase.

Another approach—Nicolas K. Fontaine, Ryan P. Scott, Jonathan P. Heritage, and S. J. B. Yoo, “Near quantum-limited, single-shot coherent arbitrary optical waveform measurements,” Opt. Express 17, 12332-12344 (2009)—employs an optical comb source as a local oscillator and then separates the spectrum into N spectral bands using an Arrayed Waveguide Grating (AWG). In contrast to the technique of Szafraniec et al, this technique does not use a tunable laser, but nonetheless does require N coherent receivers (including optical hybrids) and is limited to the bandwidth of the optical comb and the AWG.

The present application seeks to provide an alternative method\system for measurement of the phase and intensity of optical signals.

### SUMMARY

The present application uses a tunable optical local oscillator, an optical coupler, a photodiode, and RF electronics. The tunable laser enables successive measurements to be taken across the optical spectrum enabling the system to measure extremely high bandwidth signals (limited only by the tuning range of the laser, which can be of the order of THz). This offers a significant improvement over existing time resolved approaches which are limited to the bandwidth of the photodiode (˜50 GHz).

Accordingly, a first embodiment of the application provides a method as detailed in claim 1. The application also provides a system as detailed in claim 11. Advantageous embodiments are provided in the dependent claims. The application further extends to the following statements:

1. An optical measurement method for measuring a periodic optical signal comprising a series of discrete spectral modes spaced at integer multiples of a repetition rate, the method comprising the steps of:
a) generating an optical signal at a frequency between two adjacent modes of the periodic optical signal;
b) mixing the generated optical signal with the periodic optical signal;
c) providing the mixed optical signal to a photo detector to provide an electrical signal;
d) filtering the electrical signal to isolate beat frequencies resultant in the electrical signal; and
e) employing the beat frequencies to provide a measure of at least one of amplitude and phase of one or more of the adjacent modes.
2. A method according to statement 1, wherein the step of filtering results in the isolation of three beat signals, with a first beat signal resulting from the beating of the discrete modes of the periodic optical signal together and the second and third beat signals correspond to the beating of the two adjacent modes of the periodic optical signal with the generated optical signal.
3. A method according to statement 2, wherein a phase measurement is obtained by mixing the second and third beat frequencies together and then making a phase measurement between the mixed second and third beat frequencies and the first beat frequency.
4. A method according to statement 2, wherein an amplitude measurement is obtained by measurement of the amplitude of the second or third beat frequencies.
5. A method according to any preceding statement, wherein the measurement is repeated for further adjacent modes of the periodic optical signal.
6. A method according to any preceding statement, wherein the measurement is repeated for all adjacent modes of the periodic optical signal.
7. A method according to any preceding statement, further comprising the steps of splitting the electrical signal into a first electrical signal and a second electrical signal,
mixing the first electrical signal with a locally produced RF signal and then adding the second electrical signal and mixed first electrical signal together and providing this electrical signal to the filtering step.
8. An optical measurement system for measuring an optical signal comprising a series of discrete spectral modes spaced at multiples of a repetition rate, the system comprising:
a) an optical oscillator generating an optical signal at a frequency between two adjacent modes of the periodic optical signal;
b) an optical combiner for combining the generated optical signal with the periodic optical signal;
c) a photo detector for receiving the combined optical signal to provide an electrical signal;
d) at least one filter for filtering the electrical signal to isolate beat frequencies resultant in the electrical signal; and
e) a measurement circuit employing the beat frequencies to provide a measure of at least one of amplitude and phase of one or more of the adjacent modes.
9. A system according to statement 8, wherein the at least one filter comprises three filters, each filter being configured to isolate three beat signals, with a first beat signal resulting from the beating of the discrete modes of the periodic optical signal together and the second and third beat signals correspond to the beating of the two adjacent modes of the periodic optical signal with the generated optical signal.
10. A system according to statement 9, further comprising a mixer for mixing the second and third beat frequencies together.
11. A system according to statement 10, further comprising a phase detection circuit for making a phase measurement between the mixed second and third beat frequencies and the first beat frequency.
12. A system according to any one of statements 8 to 11, wherein the optical oscillator is tunable.
13. A system according to statement 12, wherein the system is configured to tune the optical oscillator and perform the measurement for further adjacent modes of the periodic optical signal.
14. A system according to any one of statements 8 to 13, further comprising: a splitter for splitting the electrical signal into a first electrical signal and a second electrical signal, a mixing circuit for mixing the first electrical signal with an RF signal to provide a mixed first electrical signal; a combining circuit for adding the second electrical signal and mixed first electrical signal together and providing this electrical signal to the at least one filter.

### BRIEF DESCRIPTION OF THE DRAWINGS

The present application will now be described with reference to the accompanying drawings in which:

FIG. 1 is an illustration of the spectral offset between two signal modes in an optical signal to be measured and the frequency of a local oscillator employed in a method of the present application;

FIG. 2 is an illustration of the method applicable to the example of FIG. 1;

FIG. 3 is a sample RF beat spectrum calculated from a real-time acquisition of the beating between a local oscillator and two adjacent signal modes of a 10 GHz source using the method of FIG. 2 and including in the inset the recovered phase difference;

FIG. 4. Schematic diagram of the complex optical spectrum analyzer;

FIG. 5 is an illustration of a situation in which the arrangement of FIG. 4 may be ineffective;

FIG. 6 is an illustration of an arrangement which may be implemented after the photodiode to address the situation;

FIG. 7 illustrates how the situation of FIG. 5 is improved using the arrangement of FIG. 6;

FIG. 8 is an illustration of the spectral offset between two signal modes in an optical signal to be measured and the frequencies of a comb local oscillator employed in a method of the present application; and

FIG. 9 is an illustration of the method applicable to the example of FIG. 8.

### DETAILED DESCRIPTION OF THE DRAWINGS

More particularly, the present application is directed at the measurement of a periodic optical signal consisting of a series of discrete spectral modes spaced at multiples of a repetition rate. The measurement provides for the measurement of the amplitude of each mode as well as the phase difference between adjacent modes. Using these measurements, it is possible to reconstruct the electric field of the input signal in either the time or the frequency domain.

The present application provides a stepped-heterodyne measurement capable of recovering the spectral amplitude and phase of a periodic optical signal. The signal under test is mixed with an optical local oscillator, whose frequency is positioned between two of the discrete signal modes. The resultant beat signals allow the recovery of the amplitude of the two modes as well as their phase difference.

By repeating this process and each time stepping the local oscillator to be between two adjacent modes and performing it across substantially all signal modes, a complete measurement of the optical signal's amplitude and phase may be obtained.

In the stepped-heterodyne technique, described herein, a measurement device such as a real-time oscilloscope is employed as an RF detection system. This allows the spectral amplitude and phase of the periodic optical signal to be determined without the need for any optical modulation of either the local oscillator or the signal under test.

The technique also permits a significant relaxation of the tuning requirements for the optical local oscillator over previous methods and generally requires no electronic clock to be passed to the receiver. This means that as well as the measurement of optical telecommunications sources, the technique is ideally suited to the measurement of passively mode locked devices and optical signals at wavelengths away from the primary telecommunications bands.

The present method and will now be described with reference to an explanation of the nature of the signals being measured. In particular, the method and system is intended to measure the complex electric field of periodic optical signals. The periodic nature of the signal reduces its spectrum to a series of discrete spectral modes spaced at multiples of the repetition rate. The present measurement approach works by measuring the amplitude of each of these spectral modes as well as the phase difference between adjacent modes. These measurements are repeated for all adjacent modes. Once these measurements have been completed it is possible to reconstruct the full electric field of the optical input signal in either the time or the frequency domain.

A difference in the method to previously suggested techniques is the real-time acquisition of the RF beat spectrum between the signal and the local oscillator. This allows the measurement to proceed without the need for either an external electronic clock, or optical modulation of the signal or local oscillator. The electric field of the periodic signal to be measured may be written generally as,

$${E}_{sig} ( t ) = {\sum }_{k = - N}^{N} ( \sqrt{{P}_{k}} exp ( j k Ω t + j {φ}_{k} ) ) exp ( j {ω}_{s} t + j {φ}_{s} ( t ) ) \qquad ( 1 )$$

where 2π/Ω is the period of the signal, where φₖ is the spectral phase of the k^{th} mode, and φₛ(t) is the phase noise of the optical carrier.

In the present application, this signal is then mixed with a signal from a local optical oscillator. The local optical oscillator is a substantially single mode optical oscillator whose electric field may similarly be expressed as E_{LO}(t)=\sqrt{P_{LO}}exp(jω_{LO}t+jφ_{LO}(t)). The optical oscillator should be tunable.

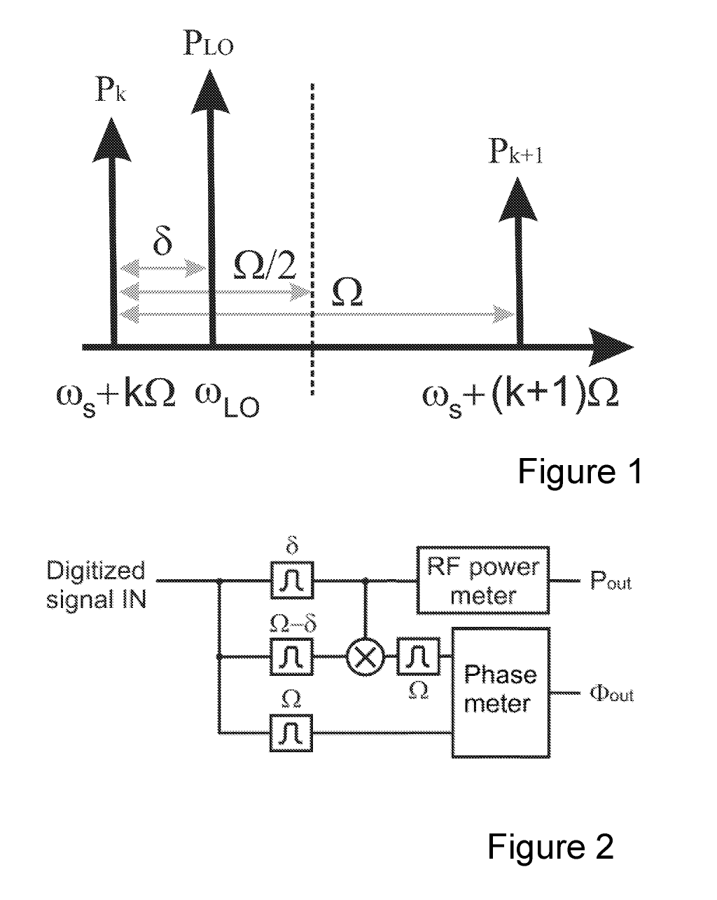

The frequency of the tunable optical local oscillator is set to be between adjacent modes (k, k+1) of the periodic optical signal. Specifically the local oscillator is detuned by a frequency δ from the k^{th} mode of the signal, so that it is asymmetrically spaced between the k^{th} and k+1^{th} signal mode (e.g. δ<Ω/2), as illustrated in FIG. 1. It will be appreciated that the alternative asymmetric convention of a spacing of δ>Ω/2 may also be employed. To prevent corruption of the phase measurement, the choice of convention should be consistent in the measurements across the modes.

The local oscillator signal may then be combined with the signal under test using an optical combiner, such as for example an optical beam splitter (free space or fiber). The resulting mixed optical signal may then be detected by a square law detector such as a photodiode. Using such a square law detector, three electrical beat signals may be generated from the mixed optical signal. These beat signals contain phase and intensity information about the modes of the periodic signal and may be used to reconstruct its complex electric field.

If the detector has a bandwidth of at least Ω the photocurrent from the detector can be expressed generally as the sum of three beat signals in addition to signals at DC and frequencies higher than Ω.

iₚₕ(t)∝B₁(t)+B_{c}(t)+DC terms+frequencies higher than Ω

The mixed signal resulting from a suitable photodetector, for example a high-speed photodiode may then be amplified (if required). The detected photocurrent may then be measured using a measurement device such as a real-time oscilloscope. The bandwidth of the photodetector and measurement device is selected to be larger than Ω, in this circumstances, the detected signal may be written as

$$B = {B}_{1} ( t ) + {B}_{2} ( t ) + {B}_{c} ( t ) \\ where \\ {B}_{1} ( t ) = \sqrt{{P}_{LO} {P}_{k}} cos ( δ t + {φ}_{LO} ( t ) - {φ}_{s} ( t ) - {φ}_{k} ) \\ {B}_{2} ( t ) = \sqrt{{P}_{LO} {P}_{k + 1}} cos ( ( Ω - δ ) t - {φ}_{LO} ( t ) + {φ}_{s} ( t ) + {φ}_{k + 1} ) \\ \begin{matrix}{B}_{c} ( t ) = {\sum }_{m = - N}^{N - 1} \sqrt{{P}_{m} {P}_{m + 1}} cos ( Ω t + {φ}_{m + 1} - {φ}_{m} ) \\ = {A}_{TOT} cos ( Ω t + {φ}_{TOT} )\end{matrix} \qquad ( 2 )$$

The first and second terms (B₁(t),B₂(t)) of Eqn. (2) represent the beat signal between the local oscillator and the k^{th} and (k+1)^{th} modes respectively. The third term B_{c}(t) is the sum of the beat signals between substantially all adjacent modes of the periodic signal and may be written as a single cosine wave at frequency Ω: A_{TOT} cos(Ωt+φ_{TOT}).

Using appropriate filtering, for example digital filters, the individual signals at each of the three beat frequencies δ, Ω−δ, and Ω (i.e. corresponding to B₁, B₂, and B_{c}) may be extracted. Once extracted, the signals may be used to perform a measurement of phase or amplitude as will now be described. Specifically, the amplitude of B₁ and B₂ may be used to provide a direct measurement of the magnitude of the k^{th} and k+1^{th} phases respectively

In particular, If the B₁(t) and B₂(t) beat terms are isolated (by filtering or use of a balanced detector) and electrically (or digitally) mixed, then a signal, Aₛ(t), is generated at the signal under test's repetition frequency Ω. This is shown by:

$${B}_{1} ( t ) \times {B}_{2} ( t ) = {A}_{s} ( t ) + {A}_{d} ( t )$$

$${A}_{s} ( t ) = \frac{{P}_{LO} \sqrt{{P}_{k} {P}_{k + 1}}}{2} cos ( Ω t + {φ}_{k + 1} - {φ}_{k} )$$

$${A}_{d} ( t ) = \frac{{P}_{LO} \sqrt{{P}_{k} {P}_{k + 1}}}{2} cos ( ( Ω - 2 δ ) t - 2 {φ}_{LO} ( t ) + 2 {φ}_{s} ( t ) + {φ}_{k + 1} + {φ}_{k} )$$

By measurement of the phase Aₛ(t) with respect to the beat signal B_{c}(t), a measure of the relative phase difference between the two adjacent modes may be obtained. Such a measurement of phase may be performed using a IQ mixer (digital or analogue). Thus by mixing the filtered signals at the beat frequencies B₁ and B₂ (δ and Ω−δ) together and calculating the phase difference between the component of this multiplied signal at Ω with the original filtered signal at Ω (i.e. that portion of the beat signal B_{c}(t)) a phase difference dφ=φₖ₊₁−φₖ−φ_{TOT} may be obtained. It will be appreciated that there is an effective cancellation of the phase noise of both the signal and the local oscillator from the measurement.

The relative power in the k^{th} mode may be determined by calculating the power in the filtered signal at δ. This procedure is illustrated schematically in FIG. 2.

It should be noted that whilst the method and system presented herein is in described in digital form, it will be appreciated that it may also be implemented in analog electronics or a combination of analog and digital form. This would result in a considerably lower cost receiver, although without some of the flexibility of an all-digital receiver.

In practice, it will be understood that some small degree of care should be taken in setting the bandwidths of the three digital band-pass filters at δ, Ω−δ, and Ω in order to obtain an optimum reconstruction of the signal's complex electric field. In particular, the spectral width of the signals at δ and Ω−δ may be set by the phase noise of both the signal under test and the local oscillator. The bandwidth of the filters should be set wide enough so as not to significantly clip any of this spectral information. The signal at Ω arises from the beating between adjacent modes of the periodic signal and as such is typically much narrower in bandwidth than the other two filtered beat signals and may be filtered more tightly than the latter.

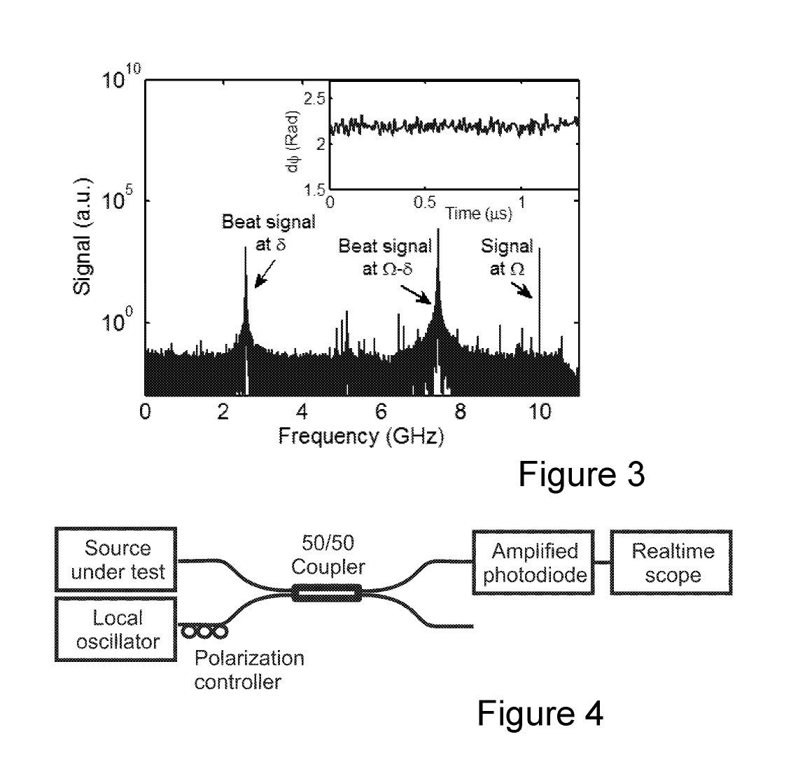

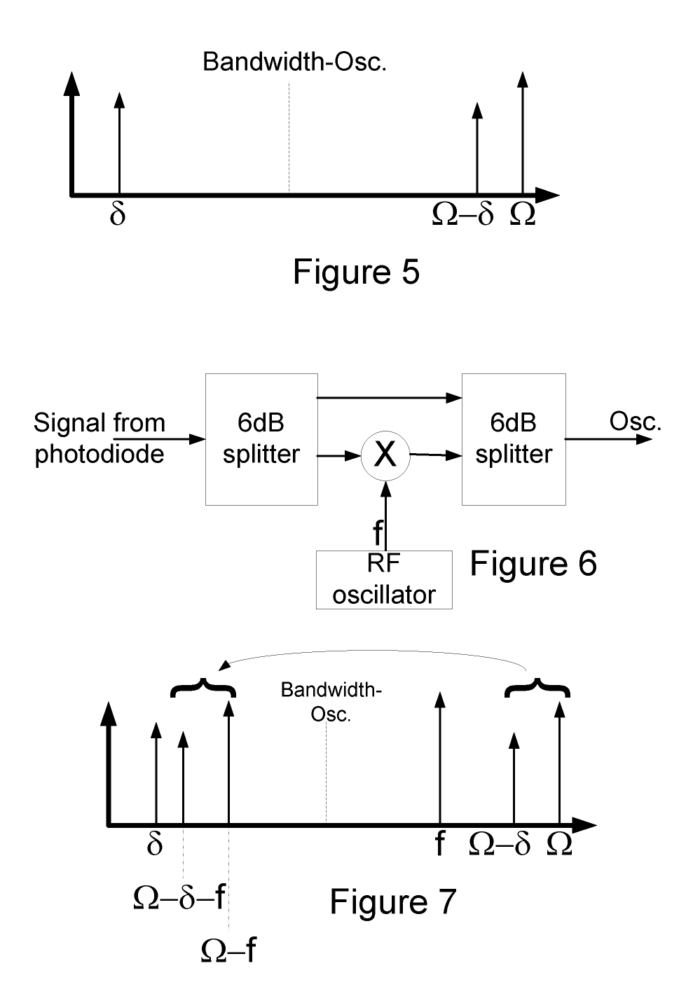

An idea of the filter bandwidth required for each signal may be simply determined by examining the RF spectrum of the acquired signal. A sample RF spectrum (2¹⁶ points, acquired at 40 GS/s) showing the beating between the local oscillator (an external cavity laser (ECL) with a linewidth ˜100 kHz) and two adjacent modes of a 10 GHz externally modulated DFB source (linewidth ˜10 MHz) is shown in FIG. 3.

As may be seen, the three beat signals of interest are clearly visible. It was found that for these exemplary signals, the use of a raised-cosine (β=0.5) band-pass filters with a 3 dB pass-band width of 100 MHz for the two beat signals at δ and Ω−δ, and a 3 dB pass-band width of 10 MHz for the signal at Ω ensures no spectral information is lost, allowing for accurate cancellation of the phase noise of the signal and the local oscillator.

Inset in FIG. 3 is the recovered phase difference between the two modes as a function of time. The phase difference dφ=φₖ₊₁−φₖ−φ_{TOT} is calculated from the mean of this signal, and its standard error may be used to assess the statistical error in the phase measurement.

The full measurement then consists of stepping the local oscillator across all modes of the signal under test, repeating the above procedure at each point. The phase of each mode may then be calculated by integrating the measured phase differences. The fact that it is only possible to determine the phase difference between adjacent modes up to a constant offset (set by φ_{TOT}) does not significantly affect the reconstruction of the signal. In the time domain this offset simply results in an overall temporal shift in the reconstructed signal and in the frequency domain it appears as a constant offset to the measured spectral group delay which can be easily removed if desired.

By tuning the optical local oscillator in between successive modes of the periodic signal the power of each mode and the phase difference between each adjacent mode can be measured. The spectral phase of the signal under test can then be reconstructed by integrating the phase difference (with respect to frequency). The complex amplitude of the spectrum of the signal under test can then by reconstructed using:

$${E}_{rec} ( t ) = {\sum }_{m = - N}^{N} ( \sqrt{{P}_{m}} exp ( j m Ω t + j {φ}_{m} ) )$$

The measurement described here generally requires neither any optical modulation of the signal or the local oscillator, nor an electronic clock to be passed to the receiver. In addition it only requires the local oscillator to be positioned generally to within an accuracy of Ω/2 of each mode. This considerably reduces the requirements for the tunability of the local oscillator.

For example, a 10 GHz signal under test only requires the local oscillator to be positioned to within 5 GHz of each mode, thus allowing for the use of discretely-tunable low-cost local oscillators such as sampled-grating DBR (SG-DBR) lasers.

It will be appreciated by those skilled in the art that the measurement generally requires the signal under test to possess an intensity modulated component at Ω (the repetition rate of the signal) to make a measurement of phase. The reason for this is that without it, the calculation of the phase difference between adjacent modes is not realisable.

Whilst some signals, for example a purely phase modulated signal, will not satisfy this condition (ie A_{TOT} is strictly zero). However, in these cases an electronic clock (at Ω) may be passed to the receiver to allow the measurement to work. In practice however, this limitation is not as severe as it may first appear as most signals, even those that theoretically do not possess any intensity modulation at Ω will usually contain a small residual intensity modulation at Ω that allows the recovery to proceed.

Thus for example, the present inventors have demonstrated the technique works for a 66% CS-RZ signal which in principle should not contain any intensity modulation at the fundamental repetition rate. Nonetheless, it was found that the presence of small residual intensity modulation remained at Ω which was sufficient to make a successful measurement.

It is to be noted that the measurement, as presented herein, is polarization sensitive, with only the component of the signal polarized parallel to the local oscillator measured. If required, polarization resolved measurements of the signal under test using this technique may be readily implemented by direct application of the polarization diverse schemes developed for optical coherent receivers. More specifically, the simple addition of a polarisation beam splitter to the local optical oscillator would allow the measurement of both polarisations in the signal. This would be advantageous in measuring Polarisation-Shift-Keyed or Polarisation-Division-Multiplexed signals (for example).

An exemplary experimental setup employed by the inventors to provide verification for this technique is shown in FIG. 4. The signal under test is mixed with an optical local oscillator (a continuously tunable, 100 kHz linewidth ECL), before detection by an amplified photodiode (11 GHz bandwidth). The resultant signal was captured on a 40 GS/s real-time oscilloscope (10 GHz bandwidth). The total bandwidth of the detection system sets the maximum repetition rate of the optical signal under test that may be measured by the system. A polarization controller in the local oscillator arm was used to ensure the two waves are collinearly polarized. Measurements were taken by discretely tuning the local oscillator so that it lies between successive adjacent modes as described in the previous section, and at each point acquiring a 1.64 μs signal trace (40 GS/s, 2¹⁶ samples).

The first source measured was a continuous-wave DFB laser externally modulated by an LiNbO₃ Mach-Zehnder modulator. The modulator drive signal at 10 GHz was set to just below 2V_{π} (peak-to-peak), and the bias was set to the null to generate 20 GHz 66% CS-RZ pulses, and to the peak to generate 20 GHz 33% RZ pulses. For this measurement the average power in both the signal and the local oscillator was 1 mW. The measured temporal phase response of these signals shows the expected behaviour with π phase jumps between adjacent pulses of the 66% CS-RZ signal, and alternating chirp between adjacent pulses of the 33% RZ signal. To further validate these results the two signals were also measured using a high-resolution optical spectrum analyzer (resolution 1 pm) and a 50 GHz photodiode and a sampling oscilloscope. These independent measurements of the optical spectrum and temporal intensity showed excellent agreement with the stepped-heterodyne measurements. From these results it was possible to infer a dynamic range for the instrument of in excess of 45 dB, and a sensitivity of better than 10 nW/mode (for an SNR=1).

In a further experiment, the capability of the instrument to measure a passively modelocked source for which no external clock is available was demonstrated. The source chosen was a passively mode locked laser centered around 1555 nm with a repetition rate of 10 GHz and a pulse width of 2 ps. It will be appreciated that this represents a challenging measurement as the average power of the source is only 100 μW spread over more than 100 modes. The spectrum of the laser was also measured with an independent high resolution optical spectrum analyzer. The distinctive quadratic phase profile resulting from propagation through a dispersive fiber was clearly visible in the recovered phase measured after 220 m of DCF. The measurements showed an excellent agreement with the measured spectral phase after 220 m of DCF and provided a simple check of the accuracy of the spectral phase measurement. A comparison of the measured group delay accumulated in the 220 m of DCF was made with the predicted group delay using the 2^{nd} and 3^{rd} order dispersion coefficients quoted above. An excellent between the two curves was shown with a standard error in measured group delay of 1.5 ps.

The methods and systems provide for the measurement of the intensity and phase of periodic optical signals via stepped-heterodyne analysis. The heterodyne nature of the measurement ensures excellent sensitivity and dynamic range. The technique has the advantage of requiring no optical modulators or filters, and no electronic clock or external optical phase reference. The technique merely requires that the local oscillator is correctly positioned to within Ω/2 of each mode, allowing for the possible use of a low-cost discretely tunable laser as the optical local oscillator. The system may be implemented in a digital receiver are in an all-analog version resulting in a considerably lower cost system, albeit one with less flexibility. The system as presented herein is capable of measuring short (less than 100 bit) pseudo-random bit-sequences (PRBS) encoded using coherent modulation formats. As such it is a useful tool for setup and analysis of coherent optical communication systems.

The above described technique is limited by the bandwidth of the RF detection circuit of the receiver (e.g. the oscilloscope) and that of the photodiode. In practise, the bandwidth of the RF detection circuit of the receiver is generally far less than that of the photodiode. Thus for example in the exemplary spectrum shown in FIG. 6, it may be seen that the repetition rate between adjacent modes is greater than the bandwidth of the oscilloscope and thus the signal corresponding to the beat signal between adjacent modes Ω is not measureable. A further embodiment provides for the extension of the bandwidth by using a local RF oscillator. This will now be explained with reference to FIG. 7 which illustrates an additional circuit which may be included between the photodiode and the RF receiver (oscilloscope). In this additional circuit, the output from the photodiode is provided to an RF splitter which seperates the RF signal from the photodiode into two substantially identical signals. One of these signals is mixed with an RF signal tone generated in a local RF oscillator. The frequency of the RF signal tone is selected so that the difference in frequency between the tone and the inter mode beat frequency Ω is less than the bandwidth of the oscilloscope.

The signal which has been mixed with the RF signal tone is then combined with the other signal from the splitter in a second splitter. It will be appreciated as shown in FIG. 7, that the mixing with the tone effectively heterodynes the fundamental frequency back to under the bandwidth of the oscilloscope. It will be appreciated that some filtering may be required to ensure that higher frequencies are eliminated. The techniques previously discussed for performing measurements on δ, Ω−δ, and Ω may now be equally be performed on δ, Ω−δ−f, and Ω−f as obtained from the circuit of FIG. 7. Any phase or phase noise of the electronic local oscillator is cancelled out.

In circumstances where the repetition rate of the signal under test is so high that you it is not possible to heterodyne the fundamental frequency back to under that of the oscilloscope in a single step, then the use of multiple mixing stages may be employed. This means, in principle, we can measure the amplitude and phase characteristics of arbitrary high rep rate optical signals. The only limitation is that the photodiode and its associated amplifier are fast enough to measure frequencies out to the fundamental repitition rate of the optical signal.

In yet another embodiment, the local oscillator could be a comb of coherent spectral modes that would span the signal under test, rather than the previously described tunable, single-frequency optical oscillator. In this further embodiment, the electric field of the periodic optical signal would still be described by Eqn. (1), however the electric field of the comb local oscillator is now described by:

$${E}_{LO} ( t ) = {\sum }_{k = - N}^{N} \sqrt{{P}_{LO , k}} exp ( j {ω}_{0} t + j δ t + j k {Ω}^{′} + j {φ}_{LO , k} )$$

where P_{LO,k} is the spectral power of the k^{th} mode of the comb local oscillator, δ is the frequency offset between the optical carrier frequencies of the periodic optical signal and the comb local oscillator, 2π/Ω′ is the period of the comb local oscillator and φ_{LO,k} is the spectral phase of the k^{th} mode of the comb local oscillator. In this embodiment, the signal under test and the comb local oscillator may be combined using an optical combiner, such as for example an optical beam splitter, and the resulting mixed optical signal then detected by a square law detector such as a photodiode. For spectral modes k=0:N, the detected photocurrent will form two sets of RF beat signals at:

δ,δ+dΩ,δ+2dΩ, . . . ,δ+(N−1)dΩ,δ+NdΩ,

and

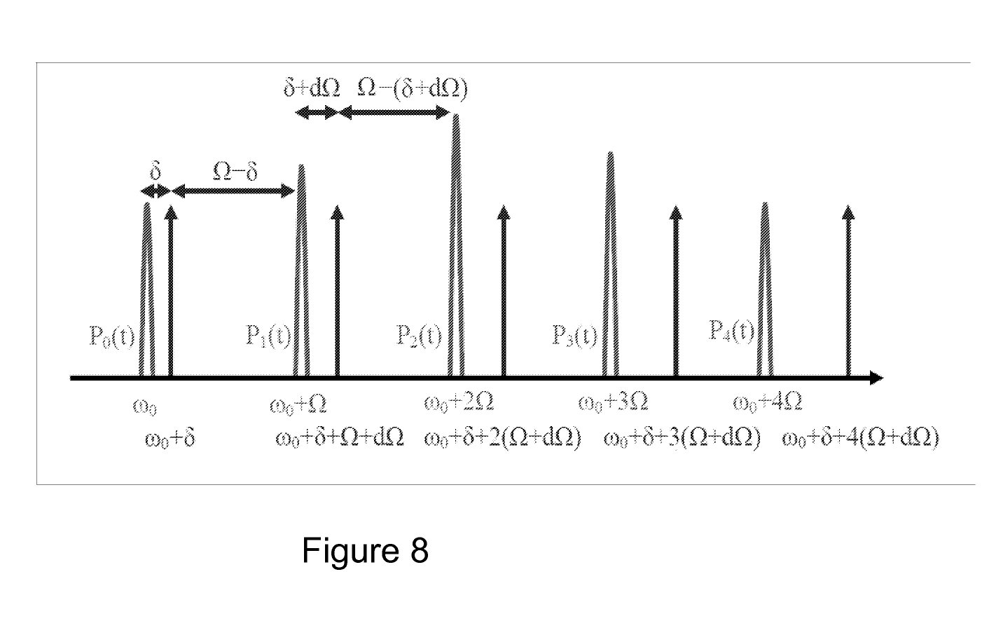

Ω−δ,Ω−(δ+dΩ),Ω−(δ+2dΩ), . . . ,Ω−(δ+(N−1)dΩ),Ω−(δ+NdΩ)

where dΩ=Ω′−Ω. FIG. 8 illustrates the spectral modes Pₖ(t) of a periodic optical signal at frequencies of ω₀+kΩ (for k=0:4), and also the spectral modes of a comb local oscillator with modes at frequencies of ω₀+δ+k(Ω+dΩ) for (k=0:4) as an example of how the comb local oscillator detuning frequency δ and frequency difference dΩ might be chosen to generate the two sets of beat signals as described above.

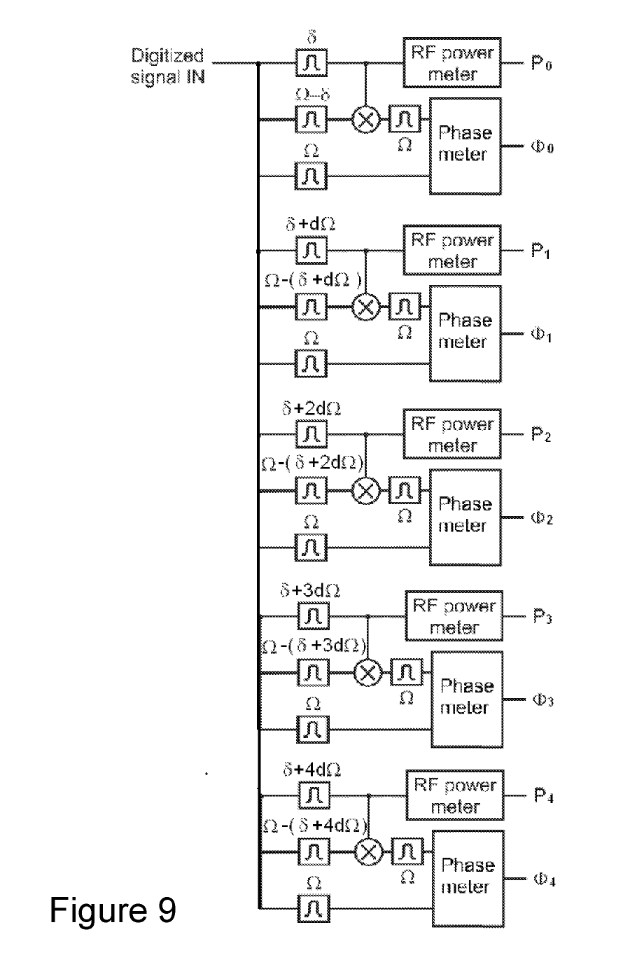

It is appreciated that these sets of beat signals take the same form as the preceding technique when using the tunable, single-frequency local oscillator; that is to say, one spectral mode of the comb local oscillator will produce beat signals at frequencies of δ and Ω−δ, which can be electrically-mixed together to provide a measure of phase difference between the two adjacent spectral modes of the signal under test. However, use of a comb local oscillator allows for the simultaneous measurement (i.e. no requirement to retune local oscillator) of all of the spectral modes of the signal under test. Thus the phase difference across the entire spectral extent may be determined in a single measurement from a real-time oscilloscope. In essence, this is a multiple optical-heterodyne mixing technique, in which the phase-difference between adjacent spectral modes may be calculated in a method similar to the preceding technique. However, in contrast to the earlier embodiments the analogue or digital electrical processing stage may suitably contain (2N+1) sets of band-pass filters and mixers, although it will be appreciated that a tunable filter mixer arrangement may also be employed, where the tunable filter mixer is adjusted for each measurement. FIG. 9 shows the ensemble of band-pass filters and mixers required to reconstruct the intensity and phase of the periodic optical signal (spectral modes k=0:4) as used in example in FIG. 8.

To ensure non-ambiguous measurement of the electric field of the signal under test, it may be desirable to employ a comb local oscillator with a known spectral amplitude and phase in this arrangement. Additionally, it would be appreciated that δ and dΩ may require careful selection to ensure that the beat signals generated from the spectral modes of the signal under test adjacent to each mode of the comb local oscillator be within the detection bandwidth of the real-time oscilloscope employed.

The words comprises/comprising when used in this specification are to specify the presence of stated features, integers, steps or components but does not preclude the presence or addition of one or more other features, integers, steps, components or groups thereof.

1. An optical measurement method for measuring a periodic optical signal comprising a series of discrete spectral modes spaced at integer multiples of a repetition rate, the method comprising:
a) generating an optical signal, the optical signal comprising a component at a frequency between two adjacent modes of the periodic optical signal;
b) mixing the generated optical signal with the periodic optical signal;
c) providing the mixed optical signal to a photo detector to provide an electrical signal;
d) filtering the electrical signal to isolate beat frequencies resultant in the electrical signal; and
e) employing the signal components of the beat frequencies to provide a measure of the phase between two adjacent modes.

2. A method according to claim 1, wherein isolated beat frequencies comprise a first beat frequency, a second beat frequency and a third beat frequency and the measure of phase is obtained by mixing the second and third beat frequencies together and then making a phase measurement between the mixed second and third beat frequencies and the first beat frequency.

3. A method according to claim 2, wherein the first beat signal results from the beating of the discrete modes of the periodic optical signal together and the second and third beat signals correspond to the beating of the two adjacent modes of the periodic optical signal with the generated optical signal.

4. A method according to claim 1, further comprising obtaining an amplitude measurement is obtained by measurement of the amplitude of the second or third beat frequencies.

5. A method according to claim 1, wherein the measurement is repeated for further adjacent modes of the periodic optical signal.

6. A method according to claim 1, wherein the measurement is repeated for all adjacent modes of the periodic optical signal.

7. A method according to claim 1, further comprising splitting the electrical signal into a first electrical signal and a second electrical signal,
mixing the first electrical signal with a locally produced RF signal, and then adding the second electrical signal and mixed first electrical signal together and providing this electrical signal to the filtering.

8. A method according to claim 1, wherein generated optical signal comprises a comb of coherent modes.

9. A method according to claim 8, wherein the comb of coherent modes substantially spans the signal under test.

10. A method according to claim 9, wherein the electrical signal is processed by a plurality of band-pass filters and mixers.

11. An optical measurement system for measuring an optical signal comprising a series of discrete spectral modes spaced at integer multiples of a repetition rate, the system comprising:
a) an optical oscillator generating an optical signal at a frequency between two adjacent modes of the periodic optical signal;
b) an optical combiner for combining the generated optical signal with the periodic optical signal;
c) a photo detector for receiving the combined optical signal to provide an electrical signal;
d) at least one filter for filtering the electrical signal to isolate beat frequencies resultant in the electrical signal; and
e) a measurement circuit employing the signal components of the beat frequencies to provide a measure of the phase between two adjacent modes.

12. A system according to claim 11, wherein the at least one filter comprises three filters, each filter being configured to isolate three beat signals, with a first beat signal resulting from the beating of the discrete modes of the periodic optical signal together and the second and third beat signals correspond to the beating of the two adjacent modes of the periodic optical signal with the generated optical signal.

13. A system according to claim 12, further comprising a mixer for mixing the second and third beat frequencies together.

14. A system according to claim 13, further comprising a phase detection circuit for making a phase measurement between the mixed second and third beat frequencies and the first beat frequency.

15. A system according to claim 11, wherein the optical oscillator is tunable.

16. A system according to claim 15, wherein the system is configured to tune the optical oscillator and perform the measurement for further adjacent modes of the periodic optical signal.

17. A system according to claim 10, further comprising:
a splitter for splitting the electrical signal into a first electrical signal and a second electrical signal,
a mixing circuit for mixing the first electrical signal with an RF signal to provide a mixed first electrical signal;
a combining circuit for adding the second electrical signal and mixed first electrical signal together and providing this electrical signal to the at least one filter.

18. A system according to claim 10, wherein the optical oscillator is a comb source providing an optical signal comprising a comb of coherent modes.

19. A system according to claim 18, wherein the coherent modes of the comb substantially span the spectrum of the signal under test.

20. A system according to claim 19, wherein there are a plurality of band-pass filters and mixers for processing the electrical signal.

21. (canceled)
